(19) United States
(12) Patent Application Publication
(10) Pub. No.: US 2007/0199023 A1
(43) Pub. Date: Aug. 23, 2007

(54) Audiovisual systems and methods of presenting audiovisual content

(76) Inventors: Kelly E. Small, Clackamas, OR (US); Clifford D. Wells, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/698,742

(22) Filed: Jan. 25, 2007

Related U.S. Application Data
(60) Provisional application No. 60/763,163, filed on Jan. 26, 2006.

(51) Int. Cl. H04N 7/18; G06F 13/00; H04N 5/445; G06F 3/00

(52) U.S. Cl. 725/45; 725/74; 725/78; 725/46

(57) ABSTRACT

A system for presenting an audiovisual program at a workstation within a healthcare office. The system includes a local area network associated with the office, having a server, a user interface associated with the server, a client device located at the workstation and connected to the server, and an audiovisual device connected to the client device. The local area network includes application(s) having instructions to: (1) store a plurality of programs; (2) receive, at the user-interface, an input corresponding to a user-selection of a subset of the programs; (3) transmit data that causes the client device to display a directory of the programs in the subset on the audiovisual device; (4) receive, at the client device, an input corresponding to a user-selection of one program from the subset; and (5) present, with the audiovisual device, the one audiovisual program. The local area network includes processor(s) for executing the instructions.

### CROSS-REFERENCE TO RELATED APPLICATION

This application claims priority under 35 U.S.C. §119(e) to U.S. Provisional Patent Application Ser. No. 60/763,163 entitled “Audiovisual Systems and Content, Methods of Presenting Audiovisual Content, and Methods of Advertising,” filed Jan. 26, 2006, the complete disclosure of which is herein incorporated by reference for all purposes.

### BACKGROUND

Some healthcare facilities include systems that allow their clients to view audiovisual content while receiving certain services from healthcare professionals. These systems may be used to present content that: (1) educates patients about a healthcare procedure; (2) entertains patients during a healthcare procedure; and/or (3) distracts patients during a healthcare procedure. Current systems for presenting audiovisual content to patients of a healthcare office generally include some type of display device connected to a media player at a workstation within the healthcare office. Patients scheduled to undergo a procedure at the workstation may be allowed to watch television, listen to music, or select a recorded program from a list. Recorded programs selected by the patient may then be presented on the display device using the media player.

For example, magnetic resonance imagery (MRI) devices have a central bore into which medical patients are placed (sometimes for long periods of time) for diagnostic scanning. Some MRI devices include audio and/or video systems inside the bore that are used to play audiovisual content during an MRI scan. The audiovisual content may be selected to entertain patients, and/or to reduce patients' anxiety caused by claustrophobia. As another example; many dental offices include work stations having monitors for displaying audiovisual content. The audiovisual content may be used to either educate or entertain dental patients. Patients may in turn select a dentist or other health care professional based on such a service. The stimuli provided by any of these systems may additionally function as an analgesic for patients that are either in pain, or undergoing painful procedures. Other examples of audiovisual systems may be found in: U.S. Pat. Nos. 3,950,086; 4,260,376; 4,934,933; 5,864,331; 6,774,929 the disclosures of which are hereby incorporated by reference in their entirety for all purposes.

### BRIEF DESCRIPTION OF THE DRAWINGS

FIG. 1 is a block diagram showing an audiovisual system according to the present disclosure.

FIG. 2 is a screen shot showing a menu that may be displayed on a user-interface 22 associated with a main server 20.

FIG. 3 is a side view of a workstation showing aspects of the audiovisual system shown in FIG. 1 that may be located at a workstation.

FIG. 4 is a screen shot showing a directory of subcategories that may be displayed on an audiovisual device located at a workstation.

FIG. 5 is a screen shot showing a directory of audiovisual programs associated with a selected subcategory.

FIG. 6 is a screen shot showing an audiovisual program, and an image overlying the audiovisual program that includes information being communicated to a patient.

FIG. 7 is a block diagram showing a method of presenting an audiovisual program.

FIG. 8 is a block diagram showing a method of communicating information to a patient.

### DETAILED DESCRIPTION

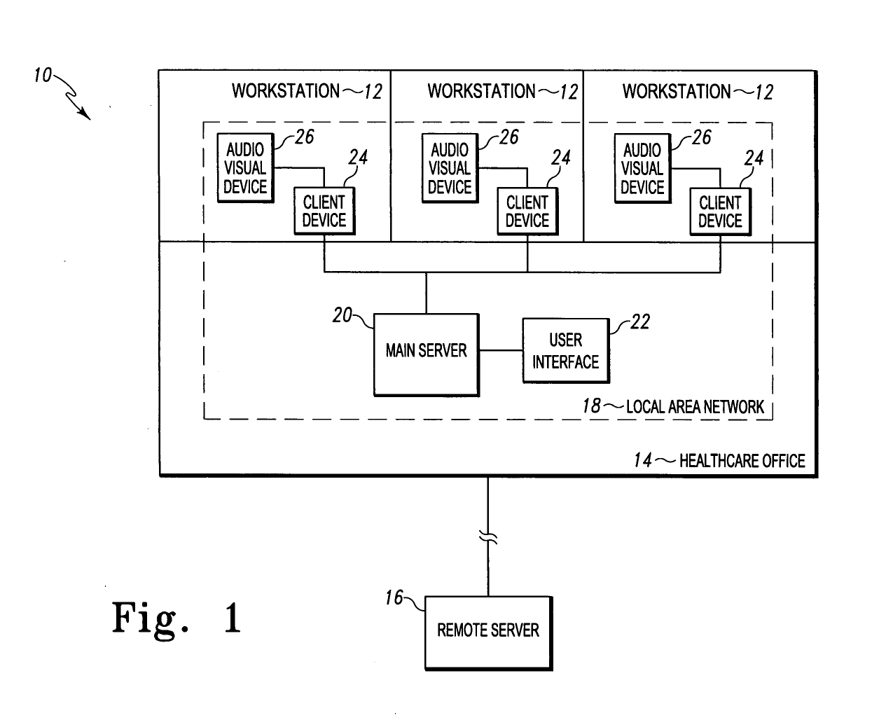

FIG. 1 is a block diagram showing a system 10 for presenting audiovisual programs at one or more workstations 12 within a healthcare office 14. The system may include a remote server 16, and a local area network 18 associated with the healthcare office.

Workstations 12 may include any workstation commonly found within a healthcare office 14. For example, a workstation may include a dental workstation, for performing a dental procedure, a computer workstation for an administrative employee of the office, a medical workstation for performing a medical procedure, or any other type of workstation that would otherwise be found in a healthcare office. As discussed in more detail below, one or more devices associated with the local area network 18 may be located at each workstation.

The remote server 16 may include any server that stores audiovisual programs, and that makes the audiovisual programs available to other systems that have established a connection with the remote server. For example, the remote server may be a web server, or some other type of server, that allows other networks to establish a connection therewith. A connection may be established via cable, satellite, the internet, or any other type of connection that enables the transfer of data. The remote server may include one or more processors (not shown) and/or one or more storage devices (also not shown). The processor may be adapted to execute one or more software applications stored on the storage device(s). The storage device(s) may be adapted to store one or more software applications and/or one or more data files.

For example, the storage device(s) associated with the remote server may include security software that ensures that a system establishing a connection with the remote server is authorized to access other software applications, and/or data files, stored on the storage device(s). Such security software may require a user accessing the remote server to enter a user name and/or password. Alternatively or additionally, such security software may be programmed to utilize built-in verification processes that verify that a particular system accessing the remote server is an authorized system. The storage device(s) may also include one or more database applications that organize data files stored on the storage device(s). The database application may also allow systems accessing the remote server to easily view and manipulate data files stored on the storage device(s). Finally, the storage device(s) may include one or more software applications that enable a system accessing the remote server to retrieve from the remote server data file(s) stored on the storage device(s).

Data files stored on the storage device(s) may include one or more audiovisual programs, such as a library of audiovisual programs, stored for the benefit of systems authorized to access and/or download some or all of the programs. These audiovisual programs may include audio files, as well as files including both audio and video content. The audiovisual programs may include metadata that allows database software to organize the audiovisual programs categorically. For example, the audiovisual programs may include entertainment programs, educational programs, and/or advertisements. Entertainment programs further may be organized according to the genre, or subgenre, of content included in the program. Educational programs further may be organized according to the intended recipient of the education (i.e. a patient, a healthcare professional, or an administrative employee). Each advertisement further may be organized based on their priority relative to the other advertisements (i.e. an advertiser may pay more to have an advertisement presented more frequently than other advertisements, whereby this frequency is reflected by an assigned priority). Finally, each audiovisual program may be organized based on the duration of the program.

The local area network (“LAN”) 18 may include any type of network of computers and associated devices sharing a common communications line within a defined area, such as a healthcare office 14. The LAN 18 may include a main server 20, a user-interface 22 associated with the main server, one or more client devices 24 connected to the main server, and audiovisual devices 26 connected to each of the client devices.

The main server 20 may include any server that stores software applications and data files, executes software applications, and transfers/receives data files to/from other computers and/or devices connected to the main server, such as a remote server 18, a user-interface 22 and/or a client device(s) 24. The main server therefore may include one or more processors (not shown) for executing software applications, and one or more storage devices (not shown) for storing data files. The main server may be adapted to establish a connection with the remote server 16 in the manner(s) discussed above. A main server connected to a remote server may be adapted to retrieve a plurality of audiovisual programs stored on the remote server. These audiovisual programs may thereafter be stored on the main server. Alternatively or additionally, audiovisual programs may be loaded onto the main server locally (such as by downloading the audiovisual content from a CD, DVD, or other portable storage device). As discussed above, each audiovisual program may include metadata that allows database software stored on the main server to organize the audiovisual programs categorically.

Storing a plurality of entertainment programs on the main server permits the healthcare office to offer their patients a variety of programs from which to select from while receiving healthcare services. This variability may make a particular patient's experience in the healthcare office more enjoyable. Storing a plurality of educational programs on the main server may help the healthcare office conserve resources, such as by providing an automated medium by which to instruct patients, healthcare professionals, or administrative employees.

The user interface 22 may include a computer and/or other device(s) connected to the main server for entering user input(s) that instruct the main server to execute software application(s), or process(es) associated with a software application. The user-interface may include a standalone computer (with an independent processor and storage device) that is in turn connected to the main server, or may simply include a display screen and one or more input devices for directly interfacing with software stored on the main server. The user-interface may be adapted to execute a software application that controls the data transmitted by the main server to each of the client devices. The user-interface may be an administrative interface that is only accessible to one or more employees of the healthcare office 14. The user-interface therefore may be inaccessible to patients of the healthcare office.

Healthcare offices may wish to control which, if any, of the audiovisual programs stored on the main server may be accessible for viewing at a particular workstation. For instance, the healthcare office may determine that some of the plurality of audiovisual programs stored on the main server are more or less appropriate for certain viewers. As an example, the healthcare office may determine that they do not want to provide child patients with the option of accessing certain adult oriented programs, such as dramas, or programs containing violence. The healthcare office may determine that they do not want to provide an administrative employee that is scheduled to use a workstation for viewing an educational program, to have the option of watching both educational programs and entertainment programs, because the employee may be tempted to watch the entertainment program when they are being paid to watch the educational program. The healthcare office may determine that they do not want to provide patients receiving a dental cleaning or root canal to have the option of watching comedies, because they do not want the patient to laugh while receiving these procedures. Finally, the healthcare office may determine that they only want to provide a patient with the option of watching audiovisual programs having durations that correspond to the length of the procedure they are scheduled to receive, because a patient would have a more enjoyable experience if they were able to watch an entire program during the procedure rather than just a portion of the program.

User-interface 22 therefore may be adapted to access and execute a software application that controls which, if any, of the audiovisual programs stored on the main server may be accessible for viewing at a selected workstation. This application may not be accessible with a client device 24, and therefore may serve as a “gateway” (with the user operating the user-interface functioning as a “gatekeeper”) for determining which audiovisual programs will be made accessible to a particular workstation at any point in time. Specifically, the gateway software may function as a database for organizing the audiovisual programs stored on the main server 20, as well a user-interface for receiving one or more user-inputs, corresponding to a user-selection of a subset of the audiovisual programs stored on the main server, where only the subset of audiovisual programs are made accessible to a client device at a selected workstation. After a subset of audiovisual programs have been selected using the gateway software, the application may be adapted to transmit data, via the main server, to the selected client device. As discussed in more detail below, this data may cause the client device to display a directory of the programs in the selected subset on the audiovisual device 26 so that a patient or employee of the healthcare office may select a program for viewing.

The local area network 18 may include more than one user-interface 22 capable of accessing and executing the gateway software application. These user-interfaces may be located anywhere in the healthcare office, including at one or more of the workstations. However, to ensure that only users authorized to function as “gatekeepers” have access to the software application, any one of the user-interfaces (such as those positioned within workstations) may include security software that requires the user to enter a username and/or password to be able to access applications on the user-interface, such as the gateway software.

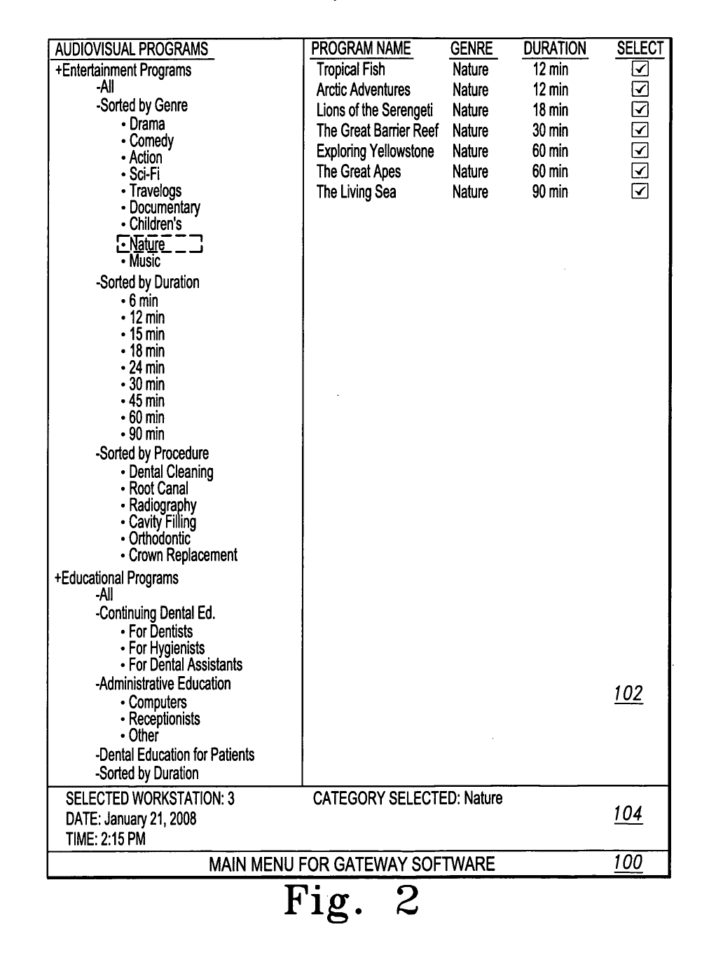

FIG. 2 is a screen shot of an exemplary main menu 100, associated with the gateway software described above, that may be displayed on a user-interface 22 associated with a main server 20. Specifically, the main menu may include a directory 102 showing the audiovisual programs stored on the main server, and a parameters field 104, for selecting the time and workstation that a subset of programs will be made available for viewing. As indicated above, each of the audiovisual programs may include metadata that allows the programs to be sorted categorically. The gateway software may allow a user to add or otherwise manipulate this metadata. The directory 102 may then show the various metadata associated with a particular audiovisual program, and may enable the healthcare office to sort the audiovisual programs into various categories.

For example, FIG. 2 shows that entertainment programs may be sorted according to genre, duration, and/or healthcare procedure, although a user may create any type of customized category. Likewise, educational programs may be sorted according to the intended viewer, or any other type of category. Some programs may fall into more than one category. For example, audiovisual programs may be categorized into a “dental cleaning” category that is predetermined to include all entertainment programs, except comedies, that have durations that substantially correspond with the length of a dental cleaning procedure (most healthcare procedures have highly predictable durations, thereby allowing the healthcare office to predict the length of program that would be desirable for a particular procedure). The gateway software application may thereby enable a gatekeeper to quickly and easily select a particular subset of the audiovisual programs to be made available for viewing at a particular workstation at any particular time. The gateway software may further enable a gatekeeper to reliably select programs that are not inappropriate for viewing by a particular viewer, such as a patient receiving a specific healthcare procedure. Thus, the healthcare provider may customize the offering set of content pieces to suit selected characteristics of a particular patient or other category of viewer in the healthcare office. As explained in more detail below, a healthcare provider may also modify or customize the offered set of primary content pieces by specifying secondary content to be overlaid on, or otherwise integrated with, whichever primary content piece is selected by the viewer.

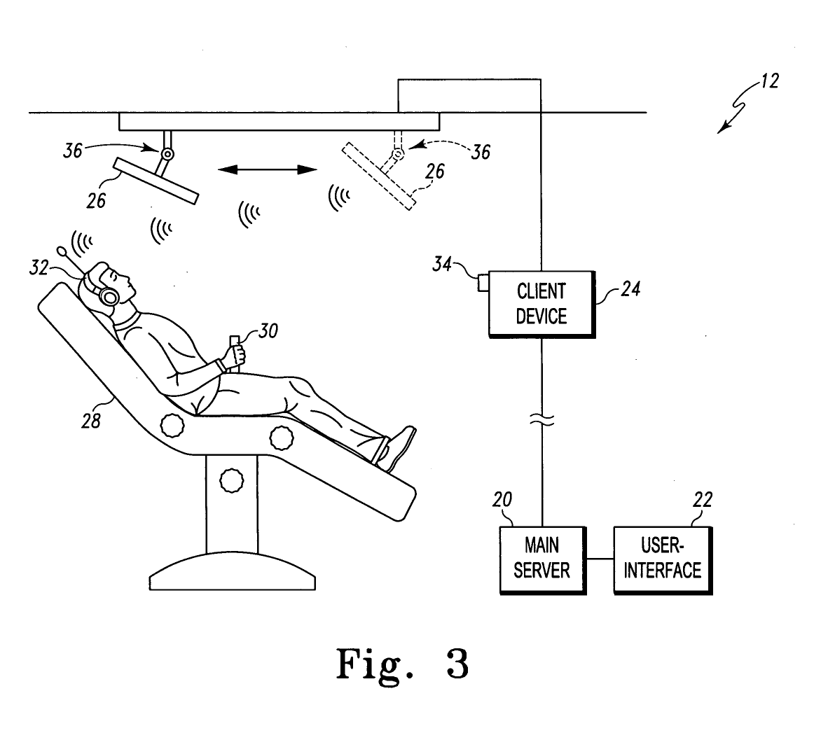

FIG. 3 is a side view of a workstation 12 showing aspects of the local area network 18 that may be located at the workstation. As discussed above, a workstation may include a dental workstation for performing a dental procedure, a computer workstation for an administrative employee of the office, a medical workstation for performing a medical procedure, or any other type of workstation that would otherwise be found in a healthcare office. As generally indicated at 28, the workstation may therefore include a patient chair, a gurney, an x-ray table, an MRI scanner, a PET scanner, a chair with or without a work desk or table, or any other apparatus at which a person may position themselves for viewing a display device. The workstation may also include a user-interface 22, a client device 24, one or more audiovisual devices 26, a remote control 30 and/or headphones 32.

The client device 24 may include any device that: (a) receives, from the main server, data that causes the client device to display on the audiovisual device a directory of the programs in the subset of programs selected by the gatekeeper; (b) receives and responds to user input(s) corresponding to a user-selection of one of the programs in the displayed subset of programs; (c) retrieves, from the main server to the client device, the one selected program; and (d) presents the one selected audiovisual program with the audiovisual device. A client device is a type of electronic device that is attached to, and served by, a server. The term “client device” therefore is not intended to require that the device be specific to a client (such as a patient) of the healthcare office. The client device may be a computer with one or more input devices, and/or may simply be a type of media player having a receiver 34 for receiving wireless signals from the remote control 30.

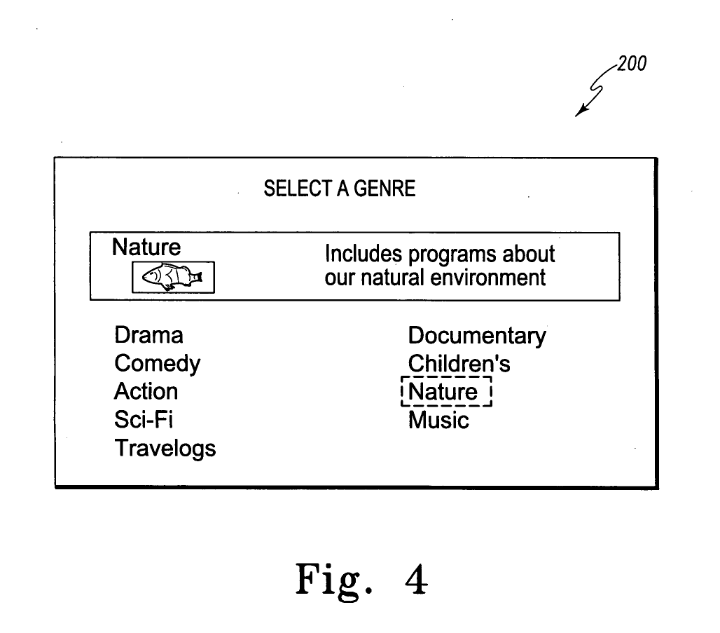

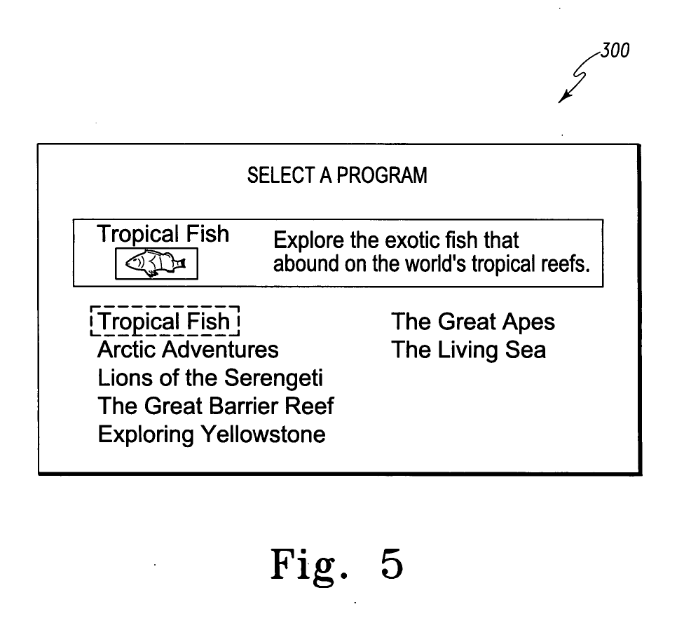

As discussed above, selection of a subset of audiovisual programs with the gateway software may cause data to be transmitted to the client device 24. The client device may in turn include an application that receives the data transmitted from the main server, and displays on the audiovisual device a directory of the programs in the selected subset on the audiovisual device 26. This directory may simply provide a list of all of the audiovisual programs in the selected subset. Alternatively or additionally, the directory may show a list of sub-categories within a selected subset (as shown generally at 200 in FIG. 4), whereby selection of a sub-category causes the client device to display either a list of sub-sub-categories, or a list of the audiovisual programs in the sub-category (as shown generally at 300 in FIG. 5). The directory of audiovisual programs may thus include an easily navigable series of menus that enable users to quickly select one of the programs for viewing. A user may navigate the directory by providing user input(s), such as wireless signals from the remote control 30, that highlight and/or execute the user's selection. Further, as shown in FIGS. 4 and 5, each menu may also include an informational box that displays a brief description of a highlighted sub-category, sub-sub-category, or audiovisual program.

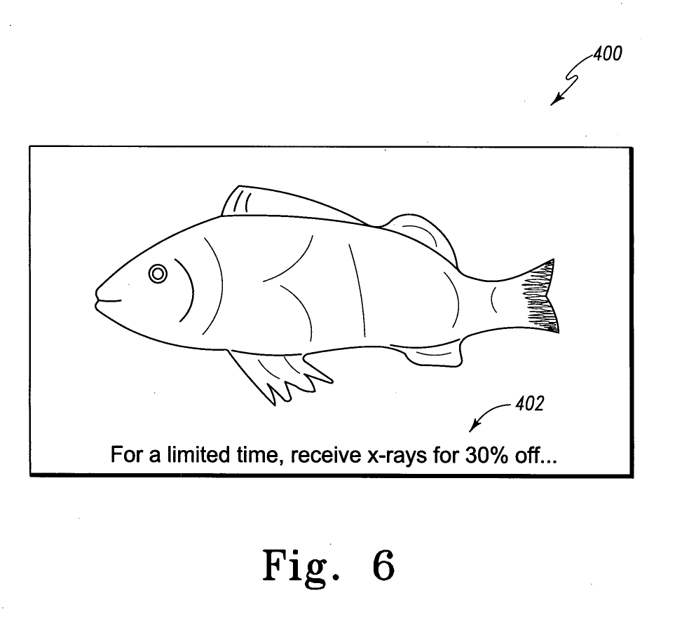

The one or more audiovisual devices 26 may include any device that receives information from the client device 24, and presents the video and/or audio content of a selected audiovisual program. For example, the audiovisual device(s) may include a video device, an audio device, and/or an auxiliary device, coupled to the client device in any manner known in the art. Video devices may include cathode ray tubes (“CRT”), plasma screens, liquid crystal displays (“LCD”), or light emitting diode (“LED”) screens. The video device may be positioned in a convenient location for a patient/client to view the screen. For example, as shown in FIG. 3, the video display may be positioned directly above a patient by attaching the video display to, or integrating it within, the ceiling. The video device's position may be adjustable, such as by providing a mount 36 that swivels, pivots or moves horizontally relative to the patient. FIG. 6 is a screen shot showing the video component 400 of an audiovisual program being presented on the audiovisual device. Audio devices may include the built-in speakers of the video device, a stand-alone audio system having an amplifier/receiver and speakers, and/or any other suitable audio system for presenting audio signals. The auxiliary device may include any device for generating signals detectable by some type of receiver, such as a transmitter for transmitting signals receivable by wireless headphones. Transmitters may utilize Bluetooth technology, or any other technology known in the art for transmitting wireless signals.

The remote control 30 may include any device that enables a user to transmit user inputs as wireless signals to the client device 24. Remote controls are well known in the art, and may include universal remote controls that selectively transmit signals receivable by one of a plurality of electronic devices.

The headphones 32 may include any device for receiving audio signals from the media player and delivering the audio content directly to a health care recipient. Depending on the particular health care provider, wireless headphones may be required so as not to hinder a health care professional's ability to provide services. For example, dentists may have a difficult time providing dental services to a client wearing wired headphones. Therefore, dentists may prefer systems that utilize wireless headphones.

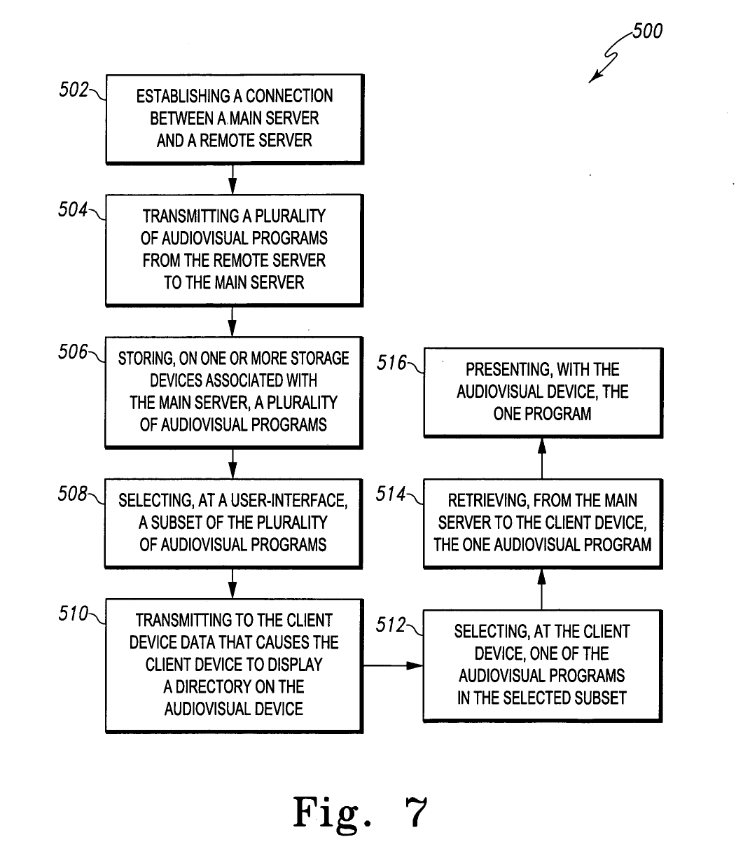

FIG. 7 shows a block diagram of a method of presenting an audiovisual program 500 consistent with the discussion above. The method may include one or more of the following steps: (a) establishing a connection between a main server and a remote server, wherein a library of audiovisual programs are stored on the remote server 502; (b) transmitting a plurality of audiovisual programs from the remote server to the main server for storage on the one or more storage devices 504; (c) storing, on one or more storage devices associated with the main server, a plurality of audiovisual programs 506; (d) selecting, at a user-interface associated with the main server, a subset of the plurality of audiovisual programs 508; (e) transmitting, from the main server to the client device, data that causes the client device to display on the audiovisual device a directory of the audiovisual programs in the selected subset 510; (f) selecting, at the client device, one of the audiovisual programs in the selected subset 512; (g) retrieving, from the main server to the client device, the one audiovisual program 514; and (h) presenting, with the audiovisual device, the one audiovisual program 516.

The audiovisual system disclosed herein may be used to advertise to a patient of the healthcare office. Health care recipients may be a captive audience to a continuous and unchanging program. Specifically, once a patient selects an audiovisual program for viewing with the audiovisual device, the patient may not have the ability to change the program without seeing and/or hearing information selectively presented along with the content associated with the selected program.

As indicated above, the main server may be used to store some audiovisual programs categorized as advertisements. The system may further include software that presents the advertisements at specific intervals during the presentment of an audiovisual program, such as at the beginning of a program, in the middle of a program and at the end of a program. The advertisements may also be categorized by priority, where high priority advertisements receive more “air time” on the audiovisual system than low priority advertisements. Selection of an advertisement may either be automatic (i.e. the system may be configured to select advertisements from a set of advertisements, such that each advertisement is presented with a frequency based on its priority), or may be manual (e.g. each particular program may have one or more pre-selected advertisements as may be specifically bargained for by the advertiser; or a particular advertisement may be shown at particular times during the day, as may also be specifically bargained for by the advertiser). Further, for healthcare offices that are concerned about providing to their patients audiovisual programs that have durations corresponding to the duration of a procedure, the duration of the entertainment portion of the program may be over-estimated to account for any additional advertisements that may be included during the presentment of the program.

Advertising may be used to directly defray the healthcare provider's costs associated with the audiovisual system by (1) increasing the demand for products and/or services offered directly by the healthcare office; and/or (2) providing advertising revenue by directly selling advertising time to advertisers that wish to take advantage of the captive audience. A healthcare office may store these advertisements on the main server, and the advertisements may thereafter be selected and presented automatically or manually, as described above. Alternatively, advertising may be an additional source of revenue for a provider of audiovisual programs (i.e. the operator of the remote server), to whom a healthcare office may subscribe. By earning additional revenue through advertising, the provider of audiovisual programs may pass some cost-savings on to the subscribing healthcare office, who may indirectly benefits from the advertisement due to less expensive subscription costs. Finally, health care providers and audiovisual program providers may negotiate specific subscriber agreements with each other based on the types of advertisements presented to the health care provider's clients. For example, dentists may wish to only present advertisements for products or services related to oral health.

The audiovisual system may also enable a healthcare office to selectively communicate information to a patient located at a workstation within the healthcare office. Specifically, a software application accessible from the user-interface 22 (which may be the same application as the “gateway software described above) may enable a user of the user-interface to provide one or more inputs corresponding to a user-selection of information to be communicated to a client. The information may be selected either (1) by typing a message that the user would like to communicate to the patient, or (2) by selecting a message from a list containing a plurality of canned messages. The software application may receive the user input(s) and may thereafter transmit, from the main server to the client computer, data that causes the client computer to display an image that includes the information and that overlies an audiovisual program while it is being presented on an audiovisual device. For example, as shown in FIG. 6, the information may be displayed as a message 402 appearing on a portion of the screen, such as the bottom of the audiovisual screen. The image may thus be displayed on the audiovisual device in a manner that does not substantially obstruct a patient's view of the audiovisual program. The image may remain on the screen for a preselected duration, or may be periodically scrolled across the screen during presentation of the program. The message may be an advertisement specific to goods/services available from the healthcare office, or may be a general announcement that the healthcare office would like to communicate to the patient.

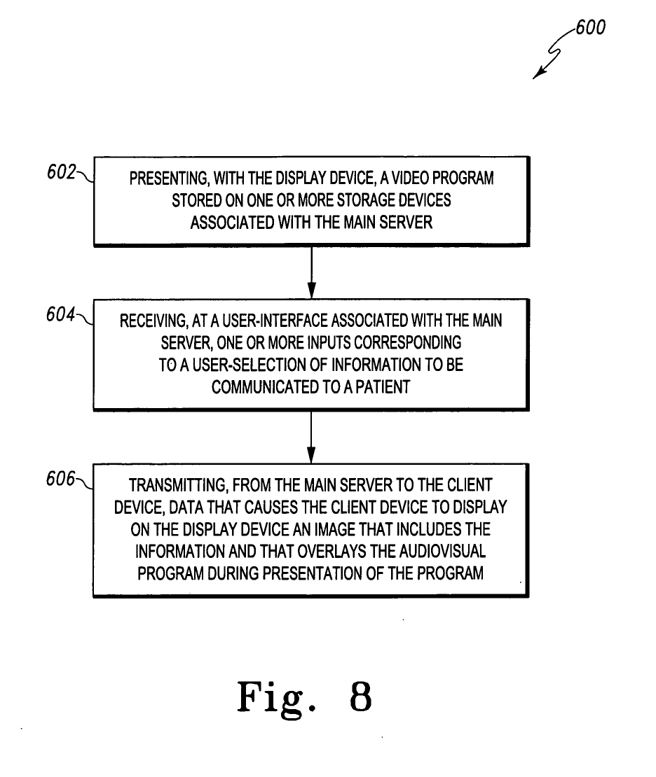

FIG. 8 shows a block diagram of a method of communicating information to a patient located at a workstation within a healthcare office 600 consistent with the discussion above. The method may include one or more of the following steps: (a) presenting, with the display device, a video program stored on one or more storage devices associated with the main server 602; (b) receiving, at a user-interface associated with the main server, one or more inputs corresponding to a user-selection of information to be communicated to a patient 604; and (c) transmitting, from the main server to the client device, data that causes the client device to display on the display device an image that includes the information and that overlies the audiovisual program during presentation of the program 606.

It is believed that this disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

It is claimed:

1. A method of presenting an audiovisual program on an audiovisual device located at a workstation within a healthcare office having a local area network that includes a main server, and a client device that is located at the workstation, and is connected to the main server and the audiovisual device, the method comprising:
storing, on one or more storage devices associated with the main server, a plurality of audiovisual programs;
selecting, at a user-interface associated with the main server, a subset of the plurality of audiovisual programs;
transmitting, from the main server to the client device, data that causes the client device to display on the audiovisual device a directory of the audiovisual programs in the selected subset;
selecting, at the client device, one of the audiovisual programs in the selected subset;
retrieving, from the main server to the client device, the one audiovisual program;
presenting, with the audiovisual device, the one audiovisual program.

2. The method of claim 1, further comprising:
establishing a connection between the main server and a remote server, wherein a library of audiovisual programs are stored on the remote server; and
transmitting a plurality of audiovisual programs from the remote server to the main server for storage on the one or more storage devices.

3. The method of claim 1, wherein the plurality of audiovisual programs are organized into a plurality of categories, each category including a subset of the plurality of audiovisual programs, and wherein the step of selecting a subset of the plurality of audiovisual programs comprises selecting one or more of the categories.

4. The method of claim 3, further comprising:
displaying on the user-interface a directory of the plurality of audiovisual programs organized by category.

5. The method of claim 3, further comprising:
scheduling a patient to receive a healthcare procedure;
assigning the patient to the workstation to receive the healthcare procedure;
wherein the step of selecting one or more of the categories comprises selecting a first category that includes a subset of audiovisual programs having content that is appropriate for viewing by a patient receiving the healthcare procedure.

6. The method of claim 3, further comprising:
scheduling a patient to receive a healthcare procedure having a substantially predefined duration; and
assigning the patient to the workstation to receive the healthcare procedure;
wherein the step of selecting one or more of the categories comprises selecting a first category that includes a subset of audiovisual programs having durations that substantially correspond with the length of the healthcare procedure.

7. The method of claim 3, further comprising:
assigning an employee of the healthcare office to the workstation to view an educational program;
wherein the step of selecting one or more of the categories comprises selecting a first category that includes a subset of audiovisual programs that are educational.

8. The method of claim 1, wherein the client device includes a receiver for receiving wireless signals, and wherein the step of selecting one of the audiovisual programs in the selected subset includes transmitting, from a remote control to the client device, one or more wireless signals corresponding to a user-selection of one of the audiovisual programs in the selected subset.

9. A system for presenting an audiovisual program at a workstation within a healthcare office, comprising:
a local area network associated with the healthcare office, wherein the local area network includes:
a main server having one or more storage devices;
a user interface associated with the main server;
a client device that is located at the workstation and is connected to the main server; and
an audiovisual device connected to the client device;
wherein the local area network includes at least one application having instructions to:
establish a connection between the main server and a remote server having a library of audiovisual programs stored thereon;
retrieve, from the remote server, a plurality of the audiovisual programs;
store, on the one or more storage devices, the plurality of programs;
receive, at the user-interface, a first input corresponding to a user-selection of a subset of the plurality of programs;
transmit, from the main server to the client device, data that causes the client device to display on the audiovisual device a directory of the programs in the selected subset;
receive, at the client device, a second input corresponding to a user-selection of one of the programs in the selected subset;
retrieve, from the main server to the client device, the one program; and
present, with the audiovisual device, the one audiovisual program; and
wherein the local area network includes at least one processor for executing the instructions.

10. The system of claim 9, wherein the plurality of audiovisual programs are organized into a plurality of categories, each category including a subset of the plurality of audiovisual programs, and wherein the first input corresponds to a user-selection of one or more of the categories.

11. The system of claim 10, wherein the at least one application further has instructions to:
display on the user-interface a directory of the plurality of audiovisual programs organized by category.

12. The system of claim 10, wherein the plurality of categories comprises a first category that includes a subset of audiovisual programs having content that is not inappropriate for viewing by a patient receiving a specific healthcare procedure.

13. The system of claim 10, wherein the plurality of categories comprises a first category that includes a subset of audiovisual programs having durations that substantially correspond with the length of a specific healthcare procedure having a substantially predefined duration.

14. The system of claim 10, wherein the plurality of categories comprises a first category that includes a subset of educational audiovisual programs.

15. The system of claim 9, wherein the client device includes a receiver for receiving wireless signals, and wherein the second input includes one or more wireless signals transmitted from a remote control to the receiver corresponding to a user-selection of one of the programs in the selected subset.

16. A method of communicating information to a patient located at one of a plurality of workstations within a healthcare office having a local area network that includes a main server, a client device connected to the main server and located at the one workstation, and a display device connected to the client device, the method comprising:
presenting, with the display device, a video program stored on one or more storage devices associated with the main server;
receiving, at a user-interface associated with the main server, one or more inputs corresponding to a user-selection of information to be communicated to a patient; and
transmitting, from the main server to the client device, data that causes the client device to display on the display device an image that includes the information and that overlies the audiovisual program during presentation of the program.

17. The method of claim 16, wherein the one or more inputs correspond to a user-selection of a message from a list containing a plurality of canned messages.

18. The method of claim 16, wherein the image is displayed on the audiovisual device in a manner that does not substantially obstruct the audiovisual program.

19. The method of claim 16, wherein the image is scrolled across the audiovisual device during presentation of the program.

20. The method of claim 16, wherein the information to be communicated to the patient includes an advertisement of goods or services available from the healthcare office.
